(19) United States
(12) Patent Application Publication
(10) Pub. No.: US 2017/0213573 A1
(43) Pub. Date: Jul. 27, 2017

(54) INFORMATION PROCESSING DEVICE, INFORMATION PROCESSING METHOD, PROGRAM,SERVER, AND INFORMATION PROCESSING SYSTEM

(71) Applicant: SONY CORPORATION, Tokyo (JP)

(72) Inventors: Naotaka TAKESHITA, Tokyo (JP); Motohiro OOHAMA, Kanagawa (JP)

(73) Assignee: SONY CORPORATION, Tokyo (JP)

(21) Appl. No.: 15/328,550

(22) PCT Filed: Jul. 21, 2015
(86) PCT No.: PCT/JP2015/070685

§ 371 Date: Jan. 24, 2017

(30) Foreign Application Priority Data
Aug. 29, 2014 (JP) 2014-175750

(51) Int. Cl. G11B 27/031; H04N 5/77; H04N 5/91; H04N 21/81; H04N 21/2743; H04N 21/258; G11B 27/34; H04N 21/235; H04N 9/87

(52) U.S. Cl. CPC G11B 27/031; H04N 21/2353; H04N 5/77; H04N 5/91; H04N 9/87; H04N 21/2743; H04N 21/25866; G11B 27/34; H04N 21/8173

(57) ABSTRACT

An information processing device according to the present disclosure includes: a plan period acquisition unit configured to acquire a period from a start to an end of a plan on the basis of plan information regarding the plan; an image data acquisition unit configured to, after the period of the plan has elapsed, acquire image data captured in the period; and a video file creation unit configured to create a video file in which the image data are combined. This configuration makes it possible to, after the period of a plan has ended, process photographs taken in the period on the basis of the plan information.

### TECHNICAL FIELD

The present disclosure relates to an information processing device, an information processing method, a program, a server, and an information processing system.

### BACKGROUND ART

Thus far, for example, Patent Literature 1 below has described specifying a creation condition corresponding to a period designated by a user and specifying a content corresponding to the specified creation condition as an object to be outputted, on the basis of information indicating the period designated by the user, the creation condition corresponding to the period, and the content corresponding to the creation condition.

### CITATION LIST

### Patent Literature

Patent Literature 1: JP 2014-17659A

### DISCLOSURE OF INVENTION

### Technical Problem

However, although the technology described in Patent Literature 1 above supposes that the content corresponding to the creation condition corresponding to the period designated by the user is taken as an object to be outputted, the technology has not supposed at all that, after the schedule has ended, photographs taken in the period are editing-processed into an optimum video file on the basis of the schedule information.

Furthermore, the technology described in Patent Literature 1 above has not supposed at all that, in the case where a plurality of users share a plan, photographs taken by the users are processed on the basis of the schedule information, either.

Thus, it has been desired to, after the period of a plan has ended, process photographs taken in the period on the basis of the plan information.

### Solution to Problem

According to the present disclosure, there is provided an information processing device including: a plan period acquisition unit configured to acquire a period from a start to an end of a plan on the basis of plan information regarding the plan; an image data acquisition unit configured to, after the period of the plan has elapsed, acquire image data captured in the period; and a video file creation unit configured to create a video file in which the image data are combined.

According to the present disclosure, there is provided an information processing method including: acquiring a period from a start to an end of a plan on the basis of plan information regarding the plan; acquiring, after the period of the plan has elapsed, image data captured in the period; and creating a video file in which the image data are combined.

According to the present disclosure, there is provided a program for causing a computer to function as: a means for acquiring a period from a start to an end of a plan on the basis of plan information regarding the plan; a means for acquiring, after the period of the plan has elapsed, image data captured in the period; and a means for creating a video file in which the image data are combined.

According to the present disclosure, there is provided a server including: an image data acquisition unit configured to acquire, from a first device, image data captured in a period from a start to an end of a plan on the basis of plan information regarding the plan; and a transmission unit configured to transmit the image data to a second device in order for the second device to create a video file in which the image data and image data captured by the second device in the period are combined.

According to the present disclosure, there is provided an information processing method including: acquiring, from a first device, image data captured in a period from a start to an end of a plan on the basis of plan information regarding the plan; and performing transmission with a transmission unit configured to transmit the image data to a second device in order for the second device to create a video file in which the image data and image data captured by the second device in the period are combined.

According to the present disclosure, there is provided a program for causing a computer to function as: a means for acquiring, from a first device, image data captured in a period from a start to an end of a plan on the basis of plan information regarding the plan; and a means for performing transmission with a transmission unit configured to transmit the image data to a second device in order for the second device to create a video file in which the image data and image data captured by the second device in the period are combined.

According to the present disclosure, there is provided an information processing system including: a server including an image data acquisition unit configured to acquire, from a first device, a first piece of image data captured by the first device in a period from a start to an end of a plan on the basis of plan information regarding the plan, and a transmission unit configured to transmit the first piece of image data to a second device; and the second device including an imaging unit configured to image a subject, a plan period acquisition unit configured to acquire the period from the start to the end of the plan on the basis of the plan information, an image data acquisition unit configured to acquire, after the period of the plan has elapsed, a second piece of image data captured by the imaging unit in the period, a receiving unit configured to receive the first piece of image data transmitted from the server, and a video file creation unit configured to create a video file in which the first piece of image data and the second piece of image data are combined.

### Advantageous Effects of Invention

As described above, according to the present disclosure, it becomes possible to, after the period of a plan has ended, process photographs taken in the period on the basis of the plan information.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a schematic diagram showing an example of the configuration of a system according to an embodiment of the present disclosure.

FIG. 2 is a schematic diagram showing screens of a terminal.

FIG. 3 is a schematic diagram showing screens of the terminal.

FIG. 4 is a schematic diagram showing screens for the invitation to a registered plan.

FIG. 5 is a schematic diagram showing a state where a server has tied the information of participants on the basis of a plan identification ID.

FIG. 6 is a schematic diagram showing an example of the data structure of the information shown in FIG. 5.

FIG. 7 is a schematic diagram showing a case where a terminal of a person to be invited has not downloaded a plan sharing application.

FIG. 8 is a schematic diagram showing a case where a terminal of a person to be invited has downloaded an application.

FIG. 9 is a schematic diagram showing an example in which a slide show is created for a plan that has ended, a “Rice-cake Making Meeting”.

FIG. 10 is a schematic diagram showing the example in which a slide show is created for a plan that has ended, a “Rice-cake Making Meeting”.

FIG. 11 is a schematic diagram showing an outline of a processing in which information for slide show creation is sent from a server to a terminal and the terminal creates a slide show on the basis of the information for slide show creation.

FIG. 12 is a schematic diagram showing a case of creating a slide show using images taken by a plurality of users.

FIG. 13 is a schematic diagram summarizing the processing up to slide show creation.

FIG. 14 is a schematic diagram showing the configuration of a terminal and a server for automatically creating a slide show.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

The description is given in the following order.

1. Configuration of plan sharing system
2. Tying of information of inviter and person to be invited based on plan identification ID
3. Case where terminal of person to be invited has not downloaded plan sharing application
4. Case where terminal of person to be invited has downloaded plan sharing application
5. Function of automatically creating slide show based on plan information

### 1. Configuration of Plan Sharing System

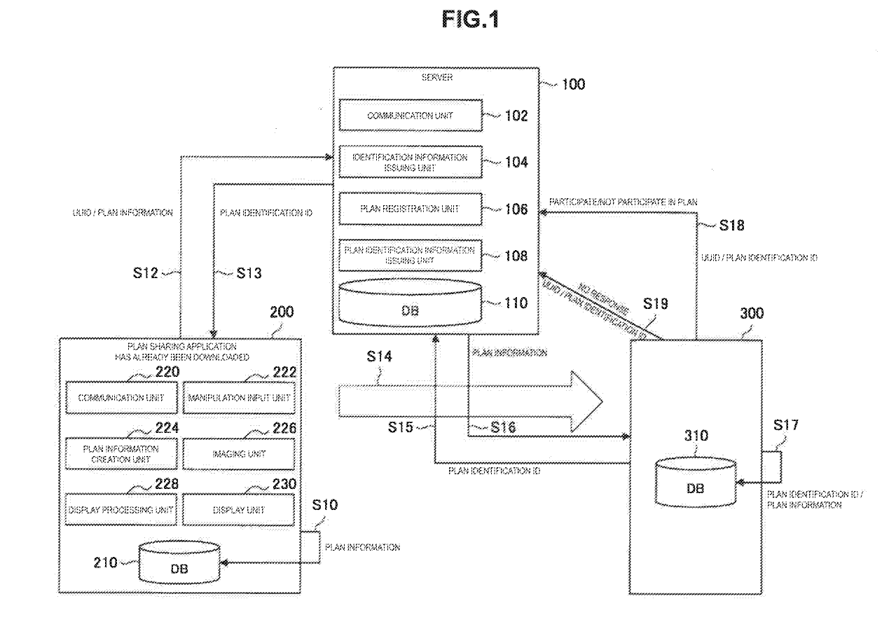

First, a rough configuration of a plan sharing system according to an embodiment of the present disclosure is described with reference to FIG. 1. FIG. 1 is a schematic diagram showing an example of the configuration of a system according to the embodiment. As shown in FIG. 1, the system according to the embodiment is configured to include a server 100, a terminal 200, and a terminal 300. The terminals 200 and 300 are, for example, a device including a display screen and a manipulation unit, such as a smartphone. Although in the embodiment a terminal including a touch panel equipped with a touch sensor on its display screen is used as the terminals 200 and 300, the terminals 200 and 300 are not limited to this.

As shown in FIG. 1, the server 100 is configured to include a communication unit 102, an identification information issuing unit 104, a plan registration unit 106, a plan identification information issuing unit 108, and a database 110. The terminal 200 is configured to include a database 210, a communication unit 220, a manipulation input unit 222, a plan information creation unit 224, an imaging unit 226, a display processing unit 228, and a display unit 230. These constituent elements shown in FIG. 1 may he configured using a circuit or a central processing device such as a CPU, and a program (software application) for causing this to function. The program may be stored in a storage unit such as a memory included in the server 100 or the terminals 200 and 300, or a memory inserted from the outside.

The communication unit 102 of the server 100 is an interface at which communication is performed with the terminals 200 and 300. The identification information issuing unit 104 issues a UUID described later. The plan registration unit 106 registers a plan when plan information and a UUID are transmitted from the terminal 200 in step S12 of FIG. 1. The plan identification information issuing unit 103 issues a plan identification ID described later. Various kinds of information regarding plan sharing are stored in the database 110.

The database 210 of the terminal 200 is a database provided in a plan sharing application described later or a database of a hard disk or the like included in the terminal 200. The communication unit 220 is an interface at which communication is performed with the server 100 or the terminal 300. The manipulation input unit 222 is a constituent element to which the manipulation by a user is inputted, such as a touch sensor or a manipulation button. The plan information creation unit 224 creates plan information described later in accordance with the user's manipulation. The imaging unit 226 is composed of an imaging element such as a CCD sensor or a CMOS sensor and an imaging optical system; and photoelectrically changes a subject image that is formed on the imaging surface of the imaging element by the imaging optical system, and thus acquires image data such as a still image or a moving image. The display processing unit 228 performs processing for performing display on the display unit 230. The display unit 230 is formed of a liquid crystal display (LCD) or the like.

In the system according to the embodiment, users share a plan using the terminals 200 and 300 the users possess, without using personal information. In the embodiment, a unique ID (hereinafter, also referred to as a UUID) is given to an application for plan sharing (hereinafter, also referred to as a plan sharing application) downloaded by the terminals 200 and 300. Further, an event identification ID is given to a plan (event) that is to be shared and is created by an individual, and an open event ID is given to a plan (event) created by a company. In the following, the event identification ID and the open event ID are referred to as a plan identification ID. Information tied to these plan identification IDs is managed on the server 100 side, and the plan identification ID is exchanged between users; thereby, the sharing of a plan is achieved.

By such a method, in the embodiment, information can be shared between any users in units of individual plans (events) without performing a complicated process such as the registration of personal information or logging-in using an ID/password (PW). In regard to once shared information, the sharing members can freely change the content, add a postscript, etc.; and even when the content is changed on the way, the changed content is quickly reflected in all the sharing users. The registration of personal information is not necessary, and a process such as logging-in is not necessary either; therefore, a plan can be easily shared between users without performing complicated processing.

For example, each user can share the user's own plan with the family and friends by merely performing simple setting based on a scheduler function (an aspect of connection to persons). Further, the latest information of the new product information of the user's favorite companies, coupons of the user's regular stores, the service information of the route for use, the information of foreign exchange and stocks, etc. can be automatically distributed by simply selecting desired information (an aspect of connection to information). Further, in cooperation with a wearable device, an alert can be made exclusively for the information needed for the user, and a life log that the device possesses can be reflected on a scheduler (an aspect of connection to articles).

To achieve the above method, the server 100 issues a UUID (unique identification information different between terminals) when a plan sharing application (plan sharing software application) is downloaded in the terminals 200 and 300. The UUID is not issued to the terminal 200 or 300, but is issued to the downloaded application. Therefore, even in the same terminal 200, a UUID is newly issued when the plan sharing application is downloaded again. The UUIDs are transmitted to the terminals 200 and 300 that have downloaded the plan sharing application, and are stored in the respective databases 210 and 310 of the terminals 200 and 300. The UUID is not notified to the user, and the user can perform subsequent manipulations without the consciousness of the issued UUID.

The users can create a plan using the respective terminals 200 and 300. The created plan is saved in the terminals 200 and 300. Further, the users of the terminals 200 and 300 can share the created plan with the users of other terminals, and can invite the other users to the participation in the plan. The server 100 manages the participants and nonparticipants in the shared plan and the persons who have not responded to the shared plan. The server 100 issues, to a plan, a plan identification ID that is hard for the user to guess and is unique. Each user sets a nickname so that the user can be identified during plan sharing. One nickname is set for one user, and the nickname may overlap with other users. Even in the case where a nickname overlaps between a plurality of users, the user can be uniquely identified using the UUID because the UUID is uniquely set for the plan sharing application downloaded by each terminal.

In FIG. 1, the terminal 200 downloads the plan sharing application, and then registers a plan in step S10. The UUID issued from the server 100 upon downloading the plan sharing application is stored in the database 210 of the terminal 200.

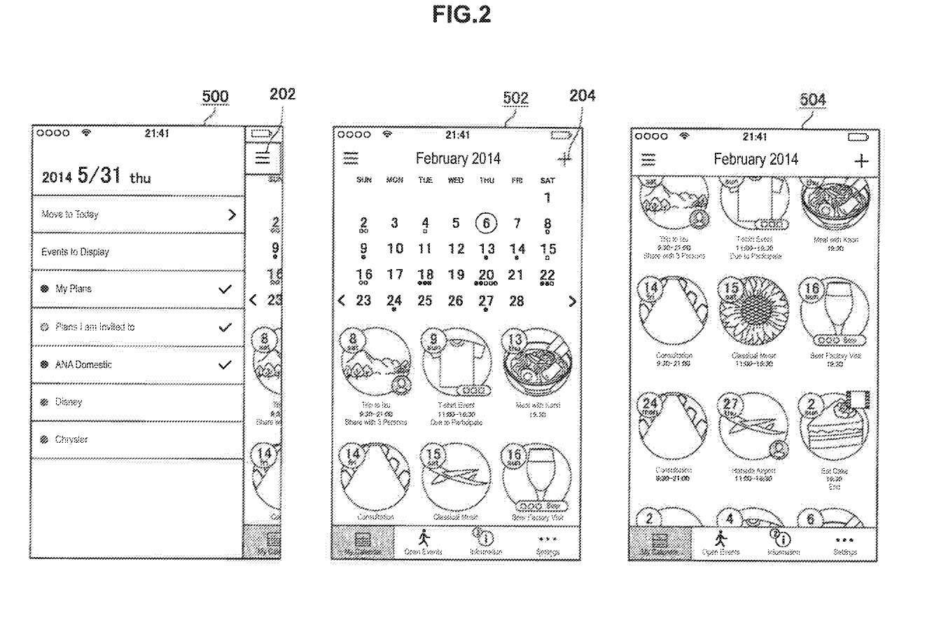

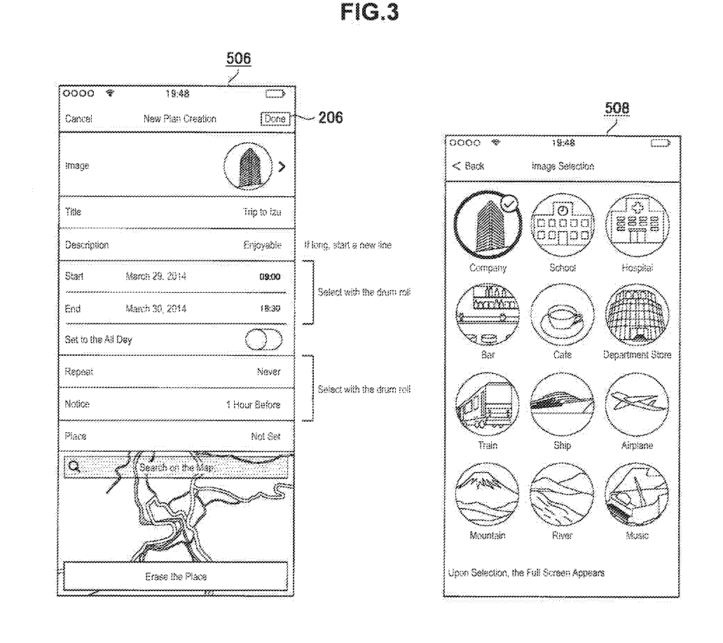

FIG. 2 is a schematic diagram showing screens of the terminal 200. In FIG. 2, screen 500 shows the initial state. When, in screen 500, “My Plans”, “Plans I am Invited to”, or “A Company's Domestic Trips” is selected as “Events to Display” by putting a check mark and button 202 is pushed in this state, the screen transitions to screen 502. In screen 502, a calendar is displayed, and the information of all the events related to the events selected as “Events to Display” (“My Plans”, “Plans I am Invited to”, or “A Company's Domestic Trips”) is displayed below the calendar. Further, as shown in screen 504 of FIG. 3, also all the events including events other than the selected events can be displayed by performing a prescribed manipulation. In screen 504, a calendar is not displayed, and the user can refer to all the events by scrolling the screen. “My Plans” and “Plans I am Invited to” are a plan (event) created by an individual, and “A Company's Domestic Trips” are a plan (event) created by a company.

When the user intends to newly register an event, button 204 may be pushed in screen 502 of FIG. 2, and the screen transitions to screen 506 of FIG. 3 (a plan new registration screen). The user registers a plan in the terminal 200 by inputting plan information such as “Title” and “Description” of the event and “Start”, “End”, and “Place” of the event in screen 506 and pushing “Done” button 206. In the case of registering “Image” in screen 506, an image can be registered by selecting it from a plurality of images displayed in screen 508 of FIG. 3. The transition from screen 506 to screen 508 can be made by manipulating a specific button. The registered “Image” is displayed in order to indicate the plan in screens 502 and 504 of FIG. 2. Thereby, the user can visually distinguish each plan through the displayed “Image” in screens 502 and 504.

When “Done” button 206 is pushed in screen 506 of FIG. 3, the registration of a plan in step S10 of FIG. 1 is completed. In the example of screen 506 of FIG. 3, “Trip to Izu” is registered as a plan. The registered plan is saved in the database 210 (see FIG. 1) in the plan sharing application of the terminal 200. Further, the registered plan is displayed below the calendar of screen 502 of FIG. 2, and is displayed in screen 504 of FIG. 2 in the case of displaying all the events.

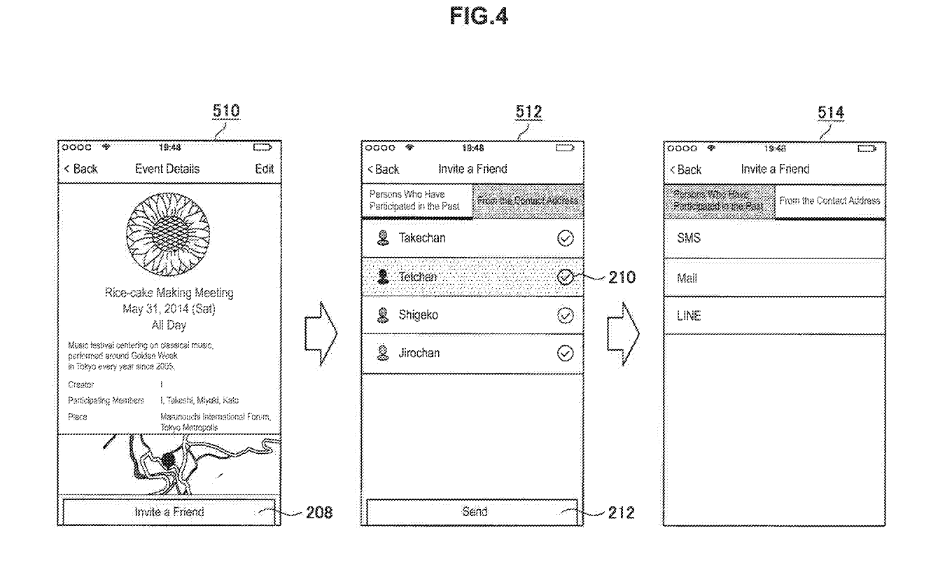

FIG. 4 is a schematic diagram showing screens for the invitation to a registered plan. When the registration of a plan in step S10 of FIG. 1 is completed, the screen can transition to screen 510 of FIG. 4 (a plan detail screen). Alternatively, the screen can transition to screen 510 of FIG. 4 by selecting, among the optional plans displayed in screen 502 or screen 504 of FIG. 2, a plan to which a friend has not yet been invited. The user of the terminal 200 may push button 208 (“Invite a Friend”) displayed on the lower side of screen 510 of FIG. 4, and thereby can share the registered plan with other users and can invite the other users to the plan.

When the user pushes button 208, the UUID of the terminal 200 and the plan information are sent to the server 100 in step S12 of FIG. 1, and the plan to which the user of the terminal 200 intends to invite other users (hereinafter, referred to as “a plan of the invitation destination”) is registered in the server 100. In order to register the plan of the invitation destination, the server 100 registers the plan information sent from the terminal 200 while tying it to the UUID of the terminal 200, and issues a plan identification ID for identifying the registered plan. The plan identification ID is sent to the terminal 200 in response in step S13. The terminal 200 that has received the plan identification ID stores the plan identification ID in the database 210.

In the above way, a plan identification ID is not issued at the stage when the user has created (registered) a plan using the terminal 200 by itself; and when the user pushes button 208 and a plan of the invitation destination is registered in the server 100, the server 100 issues and sends a plan identification ID to the terminal 200 in response.

When the user pushes button 208 in screen 510 of FIG. 4, the screen transitions to screen 512 of FIG. 4. In screen 512, the nicknames of other users are displayed, and a user intended to be invited can be selected by putting a cheek mark 210 on the nickname of the user. When the user of the terminal 200 selects a user intended to be invited and pushes button 212 in screen 512, the screen transitions to screen 514. Thereby, an invitation message is transmitted to the person to be invited (the terminal 300) in step S14 of FIG. 1. The invitation message to the person to be invited is transmitted together with the plan identification ID. Screen 514 of FIG. 4 shows the case where the terminal 300 of the person to be invited has not downloaded the plan sharing application. As described later in detail, in the case where the terminal 300 of the person to be invited has not downloaded the plan sharing application, the user of the terminal 200 who is the inviter may select any of arc SMS (short message service), a mail, and an SNS (social network service) in screen 514 of FIG. 4, and can thereby transmit the invitation message to the person to be invited using these existing applications.

The terminal 300 of the person to be invited that has received the invitation message and the plan identification ID transmits the plan identification to the server 100 in step S15. On receiving the plan identification ID from the terminal 300 in step S15, the server 100 transmits the plan information tied to the received plan identification ID to the terminal 300 in step S16. Thereby, the terminal 300 can acquire, in addition to the plan identification ID already received from the terminal 200, the plan information corresponding to the plan identification ID.

The method for acquiring the plan identification ID and the plan information depends on whether the terminal 300 has already downloaded the plan sharing application or not; this will be described later.

When the terminal 300 has acquired the plan identification ID and the plan information, the plan information of the plan of the invitation destination is displayed on the screen of the terminal 300. Further, the plan identification ID and the plan information are reflected (registered) in the database 310 of the terminal 300 in step S17 of FIG. 1.

The user of the terminal 300 manipulates the terminal 300 to input whether the user participates in the plan of the invitation destination or not. Then, when the user of the terminal 300 inputs the intention of participating or not participating in the plan of the invitation destination, the UUID of the terminal 300 and the plan identification ID are transmitted together with the information of participating or not participating from the terminal 300 to the server 100 in step S18 of FIG. 1. On the basis of the notification from the terminal 300 in step S18, the server 100 registers the fact that the user of the terminal 300 recognized from the UUID participates or does not participate in the plan corresponding to the plan identification ID. In the case where the user of the terminal 300 has not responded to the plan of the invitation destination, only the UUID of the terminal 300 and the plan identification ID are transmitted in step S19. The server 100 registers the fact that the user of the terminal 300 recognized from the UUID has not yet responded to the plan corresponding to the plan identification ID.

### 2. Tying Information of Inviter and Person to be Invited Based on Plan Identification ID

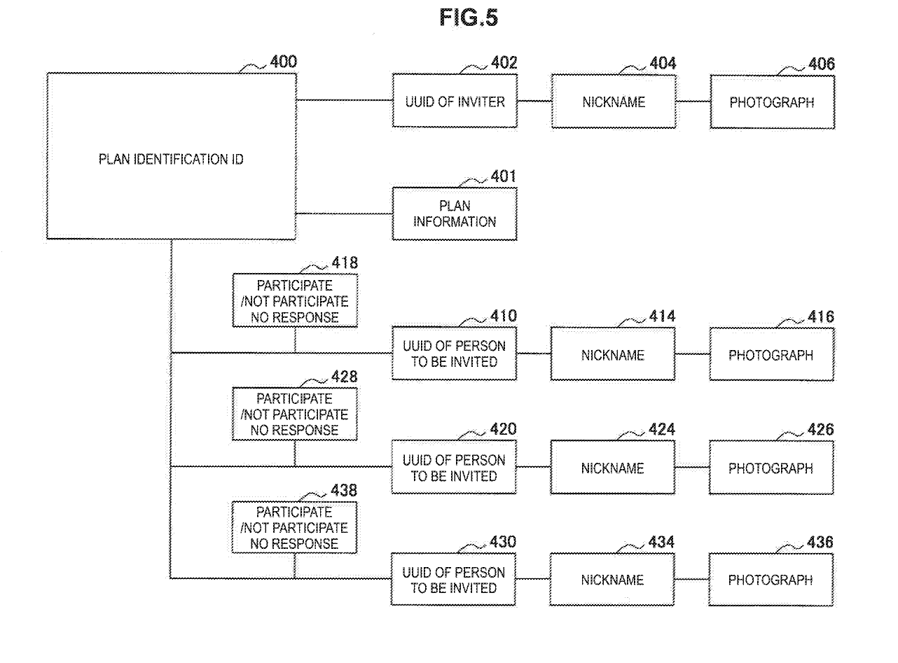

In the server 100, the information of the inviter and the person to be invited is tied on the basis of the plan identification ID. FIG. 5 is a schematic diagram showing a state where the server 100 has tied the information of an inviter and persons to be invited on the basis of a plan identification ID. As shown in FIG. 5, to a certain plan identification ID 400, the plan information 401 of the corresponding plan is tied. Further, the UUID 402 of the terminal of the inviter (the proposer of the plan) is tied to the plan identification ID 400, and the nickname 404 and a photograph 406 of the inviter are tied to the UUID 402.

Further, the UUIDs 410, 420, and 430 of the terminals of the persons to be invited are tied to the plan identification ID. The nickname 414 and a photograph 416 of a person to be invited are tied to the UUID 410 of the terminal of the person to be invited. Similarly, the nickname 424 and a photograph 426 of a person to be invited are tied to the UUID 420 of the terminal of the person to be invited, and the nickname 434 and a photograph 436 of a person to be invited are tied to the UUID 430 of the terminal of the person to be invited.

The server 100 manages pieces of participation information 418, 428, and 438 of “participate”, “not participate”, and “no response” of the persons to be invited in accordance with the notifications from the terminals of the persons to be invited.

FIG. 1 shows the tying of the information corresponding to one plan identification ID 400. In the case where N plans are registered, the server 100 manages N pieces of the information shown in FIG. 5.

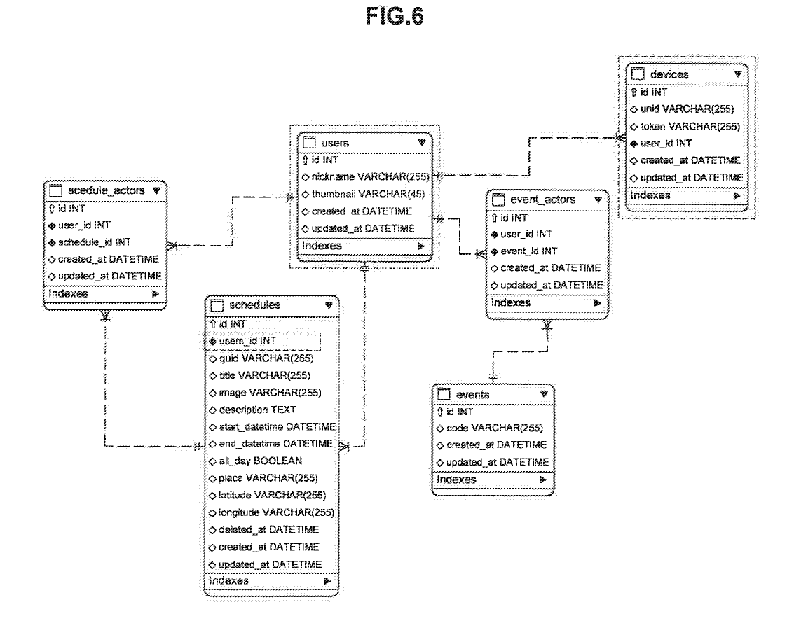

FIG. 6 is a schematic diagram showing an example of the data structure of the information shown in FIG. 5. In the example shown in FIG. 6, management is made while the information of FIG. 5 is rearranged for the items of “schedule actors”, “schedules”, “users”, “event actors”, “events”, and “devices”. In the item of “schedules” among them, the plan information is provided with the information of the creator of the plan. In the item of “users”, the information of the user is managed. In the item of “devices”, terminal information is managed. As shown in FIG. 6, information regarding the updating of the plan information (updated_at DATETIME) is included in each item. When the plan information is updated by the users of the terminals 200 and 300, the information is transmitted together with the plan identification ID to the server 100, and the server 100 updates the plan information tied to the plan identification ID.

3. Case where Terminal of Person to be Invited has not Downloaded Plan Sharing Application

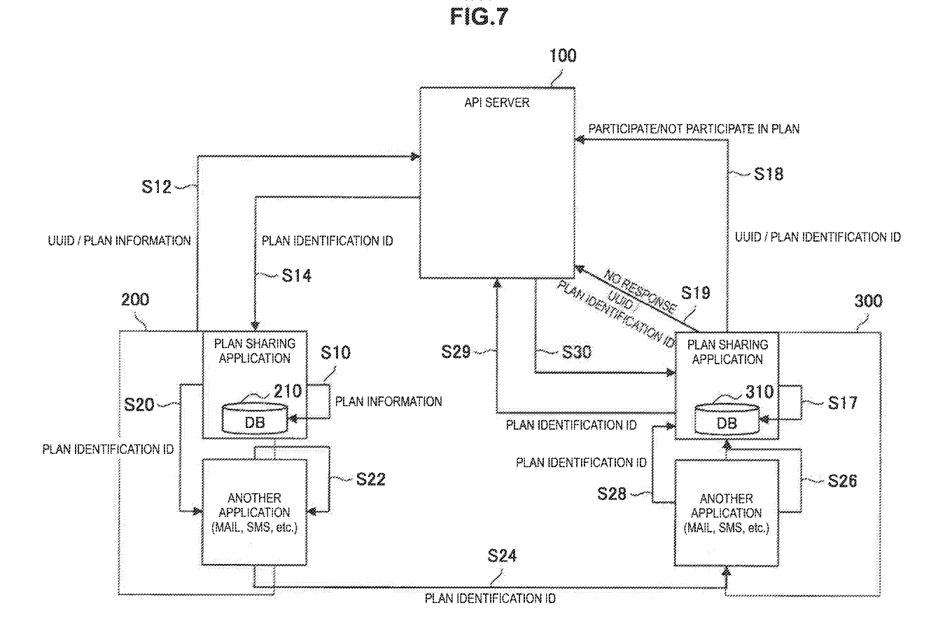

As described above, the course through which the terminal 300 acquires the plan identification ID and the plan information depends on whether the terminal 300 of the person to be invited has already downloaded the plan sharing application or not. FIG. 7 is a schematic diagram showing in detail the case where the terminal 300 of the person to be invited has not downloaded the plan sharing application. In this case, when the user of the terminal 200 registers a plan of the invitation destination in the server 100 in step S12 and a plan identification ID is sent to the terminal 200 in response in step S14, an application (an existing communication application such as a mail, SMS, or SNS) other than the plan sharing application is started up in step S20, and the plan identification ID is sent to the other application. Then, in the next step S22, information regarding the address of a person to be invited who is selected by the user in screen 512 of FIG. 4 is notified to the other application such as a mail, SMS, or SNS.

In the next step S24, an invitation message is transmitted to the terminal of the person to be invited selected by the user, through the other application such as a mail, SMS, or SNS, Herein, it is assumed that the user of the terminal 300 is the person to be invited. At this time, the plan identification ID is transmitted to the terminal 300 via the invitation message. A download link (DL link) for downloading the plan sharing application is included in the invitation message. The download link is displayed on the screen of the terminal 300 that has received the invitation message.

The user of the terminal 300 that has received the invitation message through the other application such as a mail, SMS, or SNS may click the download link included in the invitation message, and thereby the plan sharing application is installed in the terminal 300 in step S26 of FIG. 7, For example, the connection to a download site of a store on the Web is made by clicking the download link, and the plan sharing application is downloaded from the download site. When the plan sharing application is installed in the terminal 300, the plan sharing application is started up from a link in the invitation message in step S28.

The information of the plan identification ID is included in the invitation message. Hence, when the plan sharing application is started up in step S28, the plan identification ID is transmitted to the server 100 in step S29. On receiving the plan identification ID, the server 100 transmits the plan information tied to the plan identification ID to the terminal 300 in step S30.

Specifically, the information of the plan identification ID is included in the information of the URL of the download link in the invitation message. Since the history of the URL, can be found through the information of the cookies of the browser after the download, the plan sharing application can acquire the information of the plan identification ID. Therefore, the plan identification ID can be transmitted to the server 100 simultaneously with the startup of the plan sharing application in step S29. Thus, when the plan sharing application is started up from a link in the invitation message, the server 100 can acquire the plan identification ID.

When the terminal 300 has acquired the plan information tied to the plan identification ID in step S30, the subsequent processing is similar to FIG. 1. That is, when the terminal 300 has acquired the plan identification ID and the plan information, the plan information of the plan of the invitation destination is displayed on the terminal 300. Further, the plan identification ID and the plan information are reflected (registered) in the database 310 of the terminal 300 in step S17. When the user of the terminal 300 inputs the intention of participating or not participating in the plan of the invitation destination, the UUID of the terminal 300 and the plan identification ID are transmitted together with the information of participating or not participating from the terminal 300 to the server 100 in step S18. When the user of the terminal 300 does not input the response of participating or not participating, only the UUID of the terminal 300 and the plan identification ID are transmitted in step S19.

4. Case where Terminal of Person to be Invited has Downloaded Plan Sharing Application

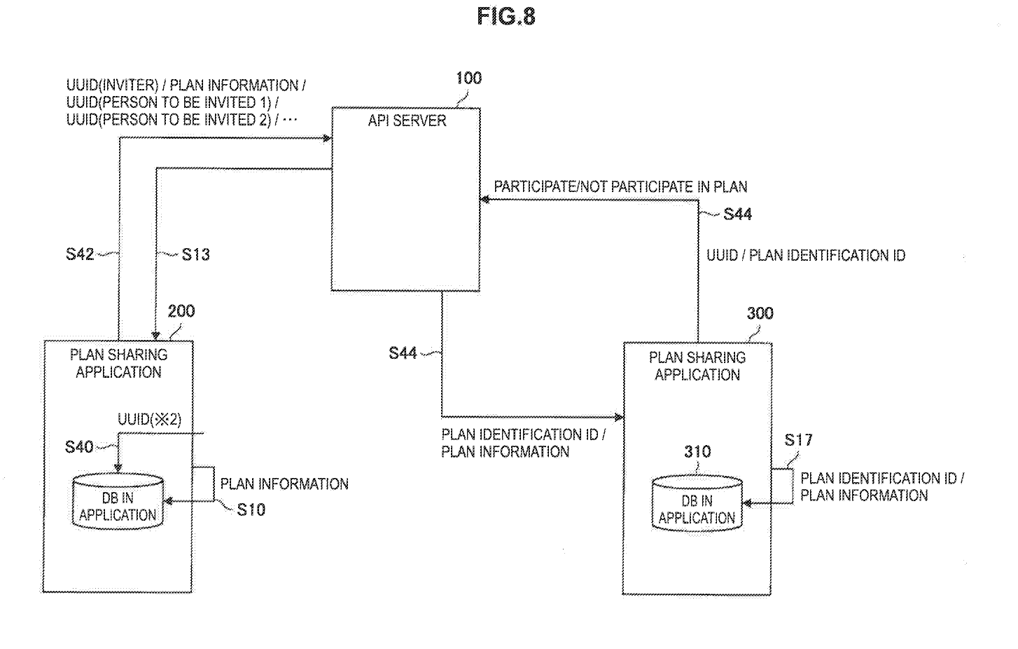

FIG. 8 is a schematic diagram showing the case where the terminal 300 of the person to be invited has already downloaded the plan sharing application. In this case, a plan can be shared using the plan sharing application already downloaded by the terminal 300. Like in FIG. 7, a plan can be shared also through an existing communication application such as a mail, SMS, or SNS. The processing in the case where a plan is shared through a mail, SMS, SNS, or the like is basically similar to FIG. 7, but is different from the processing of FIG. 7 in that it is not necessary to perform the processing of clicking a download link to download the plan sharing application (step S26).

First, when the registration of a plan in step S10 is completed, persons to be invited are selected in step S40. Specifically, button 208 displayed on the lower side of screen 510 of FIG. 4 (“Invite a Friend”) is pushed, and persons to be invited are selected in screen 512 of FIG. 4. These processings are similar to FIG. 7. At this time, in a case where the person to be invited is a user who has been invited in the past or other like cases, the plan sharing application of the terminal 200 recognizes the UUID of the person to be invited in advance.

By pushing button 212 of screen 512 in a state where a person to be invited is selected, the registered plan can be shared with the other user, and the other user is invited to the plan (step S42). At this time, although in step S12 of FIG. 1 the UUID of the terminal 200 and the plan information are transmitted to the server 100, in step S42 of FIG. 7 not only the UUID of the terminal 200 and the plan information but also the UUIDs of the persons to be invited are sent to the server 100.

In order to register the plan of the invitation destination, the server 100 registers the plan information sent from the terminal 200 while tying it to the UUID of the terminal 200, and issues a plan identification ID for identifying the registered plan. The plan identification ID is sent to the terminal 200 in response in step S13. In the server 100, also the tying of the plan identification ID and the UUID of the person to be invited is performed, and at first the person to be invited is registered as a person who has not responded.

After that, the plan identification ID is transmitted together with the plan information from the server 100 to the terminal 300 having the UUID of the person to be invited, in step S44. Thereby, the terminal 300 of the person to be invited obtains the plan identification ID and the plan information. Therefore, unlike the processing of FIG. 7, the terminal 300 does not need to send the plan identification ID to the server 100 in order to acquire the plan information. When the terminal 300 has acquired the plan identification ID and the plan information, the plan information of the plan of the invitation destination is displayed on the terminal 300. Further, the plan identification ID and the plan information are reflected (registered) in the database 310 of the terminal 300 in step S17. When the user of the terminal 300 inputs the intention of participating or not participating in the plan of the invitation destination, the UUID of the terminal 300 and the plan identification ID are transmitted together with the information of participating or not participating from the terminal 300 to the server 100 in step S46. When the user of the terminal 300 does not input the intention of participating or not participating in the plan of the invitation destination, the processing of step S46 is not performed, and the server 100 continues to treat the terminal 300 as a person who has not responded.

As shown in FIG. 8, in the case where the terminal 300 has already downloaded the plan sharing application, the server 100 can transmit the plan identification ID and the plan information to the terminal 300 of the person to be invited, on the basis of the MAD of the person to be invited transmitted from the terminal 200. Therefore, the terminal 300 of the person to be invited does not need to transmit the plan identification ID to the server 100 to acquire the plan information; thus, the processing can be simplified.

As described above, by the embodiment, a UUID can be set for the terminals 200 and 300 that have downloaded the plan sharing application. Then, the server 100 can tie the terminals 200 and 300 of the users and a plan on the basis of the UUIDs. Thus, the user can share a plan by a simple procedure without the need to perform processing such as logging-in.

### 5. Function of Automatically Creating Slide Show Based on Plan Information

Next, the function of automatically creating a slide show based on plan information is described. In the embodiment, when a plan has ended, the memory of it can be automatically made into a slide show (or a movie of moving images) using images that the terminal 200 took between the start and the end of the plan. At the time of the automatic creation of a slide show, the creation is performed on the basis of the plan information that the terminals 200 and 300 possess, images taken in the plan time set in the plan information, and information for slide show creation (including a slide show effect and music).

A conventional calendar has value mainly in present or future information; on the other hand, the embodiment can also make past information valuable by causing a slide show to be created on the basis of past information set in the plan information. Furthermore, even when the user does not have technical knowledge, a slide show can be automatically created on the terminals 200 and 300 side. Moreover, a created slide show can be shared with friends and the family, and can be socially uploaded through an SNS or the like.

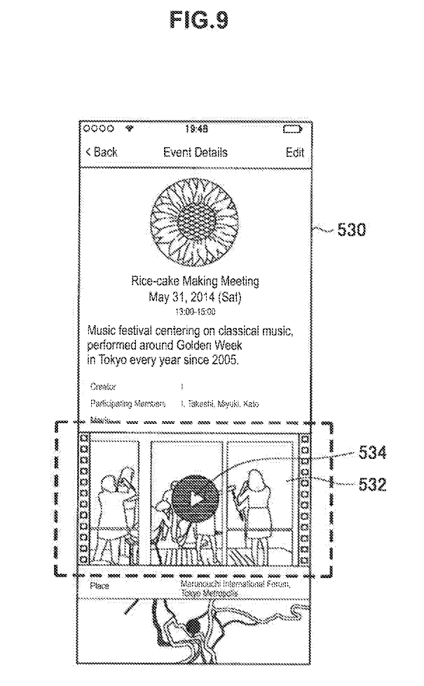

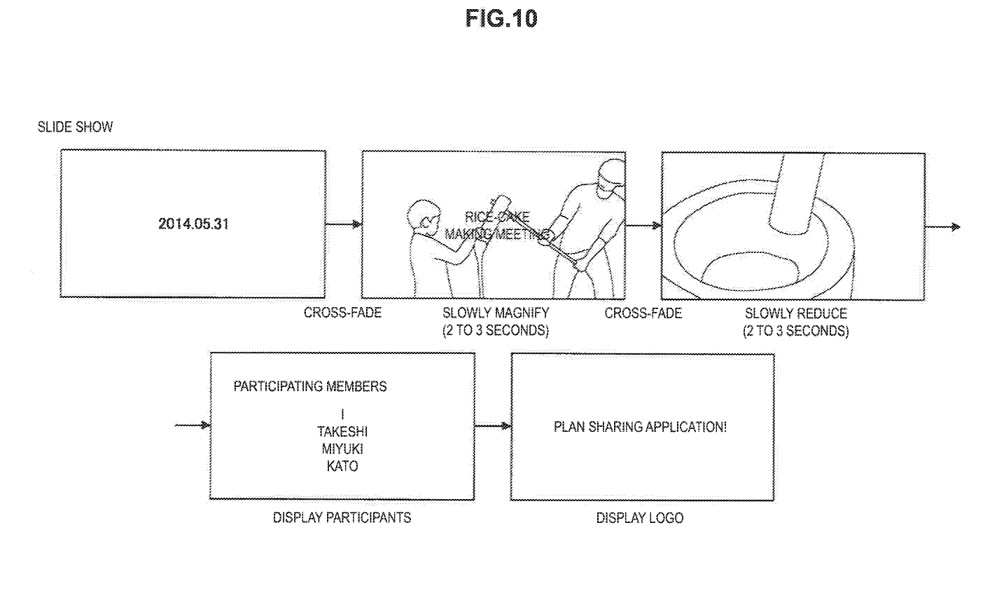

FIG. 9 and FIG. 10 are schematic diagrams showing an example in which a slide show is created for a plan that has ended, a “Rice-cake Making Meeting”. FIG. 9 shows an example in which, after the plan shown in screen 510 of FIG. 4, a “Rice-cake Making Meeting”, has ended, a slide show is automatically created and screen 532 for the playing of the slide show is automatically displayed in screen 530 in which the plan information is displayed, FIG. 10 shows the content of the slide show that the terminal 200 has automatically created for the plan “Rice-cake Making Meeting”. When play button 534 of play screen 532 shown in FIG. 9 is pushed, the slide show shown in FIG. 10 starts.

The slide show shown in FIG. 10 is created on the basis of the plan information. First, the date and time when the plan “Rice-cake Making Meeting” was performed (5/31/2014) is displayed and cross-faded, and then the first image is displayed together with the title and is slowly magnified for 2 to 3 seconds. When the first image is cross-faded and replaced with the next image, the next image is slowly reduced for 2 to 3 seconds. After that, the subsequent images are displayed one after another by a similar method, then the participants are displayed, and the logo of the plan sharing application, “Plan Sharing Application!”, is displayed.

The linkage between the plan information and the slide show is performed on the basis of the date and time, the title of the event, the participants (arbitrary), a description of the event, and the place of the event (arbitrary) included in the plan information. The terminal 200 picks up photographs in the database 210 on the basis of the date and time included in the plan information, and creates slide show moving images, with music put on.

As above, the terminal 200 by itself can automatically create a slide show using the date and time included in the plan information and the photographs taken in the period of the plan. Similarly, also the terminal 300 by itself can automatically create a slide show using the date and time included in the plan information and the photographs taken in the period of the plan.

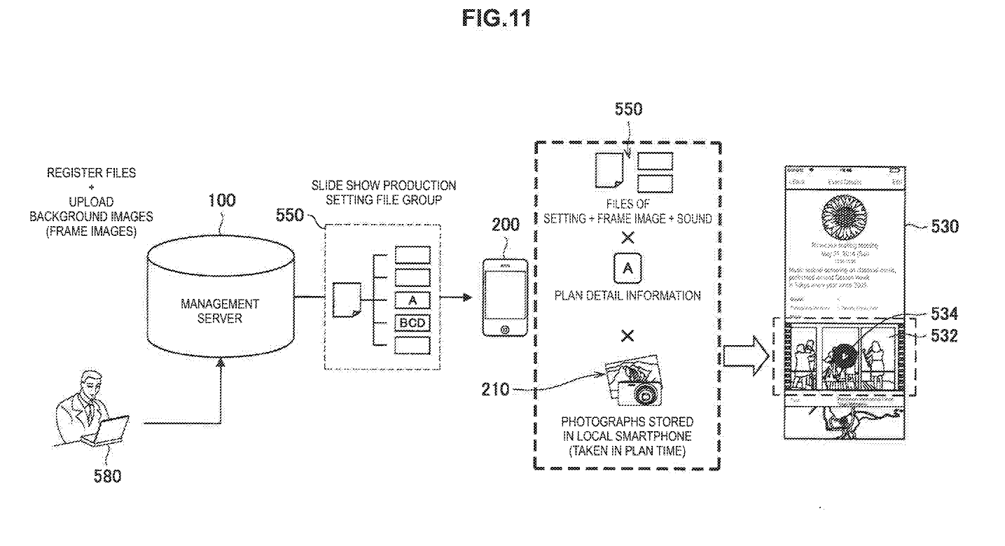

When the terminal 200 creates a slide show, the creation is performed on the basis of information for slide show creation (instruction information). FIG. 11 is a schematic diagram showing an outline of a processing in which information for slide show creation is sent from the server 100 to the terminal 200 and the terminal 200 creates a slide show on the basis of the information for slide show creation. As shown in FIG. 11, the server 100 sends a slide show production setting file group 550 as information for slide show creation to the terminal 200. The slide show production setting file group 550 includes information such as a production target condition (for general viewers, for a specific company channel, or for a specific (open) event), a frame image (background image), BGM sound, a production pattern (the display time and the production technique (cross-fading etc.)), display information (extracted from plan detail information, including text information), and the total production time.

When the slide show production setting file group 550 indicates that the plan is created by an individual and the production target condition is “for general viewers”, the terminal 200 creates an ordinary slide show without inserting an advertisement of a company or an advertisement of an open event. In the case where the plan is created by a company and the production target condition is “for a specific company channel”, an advertisement of the specific company is inserted, or a slide show in line with the brand image of the company is created. In the case where the production target condition is “for a specific (open) event”, a slide show in line with the specific event is created. For example, in the case where the open event is a soccer game, the production is set so as to make a slide show having a lively feeling matched with the soccer game.

Also a frame image (background image), BUM sound, a production pattern (the display time and the production technique (cross-fading etc.)), display information (extracted from plan detail information), the total production time, etc. are prescribed in detail by the slide show production setting file group 550. Thus, the slide show production setting file group 550 serves as a specification at the time when the terminal 200 creates a slide show.

As shown in FIG. 11, the slide show production setting file group 550 is sent from the server 100 to the terminal 200, and the terminal 200 creates a slide show on the basis of the slide show setting file group 550. In the server 100, the slide show production setting file group 550 is registered in advance, and frame images (background images) included in the slide show setting files are uploaded.

In the case where the plan is created by a specific company, the relevant staff member of the company may manipulate a terminal 580, and can thereby edit the slide show production setting file group 550 into one suitable for the specific company. In this case, for example, by editing the information of “for a specific company channel” of the production target condition, a slide show can be edited so as to be in line with the image of the specific company.

At the time point at which the plan has ended, the terminal 200 creates a slide show using the data of the photographs stored in the database 210 of the terminal 200, on the basis of the slide show production setting file group 550 and the plan information. Thereby, play screen 532 is automatically displayed in screen 530. The created slide show can be played on the terminal 200 by pushing button 534, and can be shared with other users through social media or the like.

Although in the example described above the server 100 sends the information for slide show creation to the terminal 200, the terminal 200 may possess the information for slide show creation in advance. For example, when the plan sharing application is downloaded, also the information for slide show creation may be downloaded. In this case, the terminal 200 can create a slide show without communicating with the server 100.

Next, the case of creating a slide show on the basis of photographs taken by a plurality of users who participated in a plan is described.

By the method described above, the user of the terminal 200 can automatically create a slide show on the basis of photographs taken by the user oneself. On the other hand, in the embodiment, a plurality of users can share a plan; by the participation of a plurality of users in a plan, photographs of the plan (event) are taken by the plurality of users who participated. In this case, the terminals 200 and 300 can also create a slide show on the basis of the photographs taken by the plurality of users who participated. Thus, by creating a slide show on the basis of the photographs taken by the plurality of users who participated in the plan, a slide show can be created using various photographs taken by different photographers. Therefore, although it is anticipated that, when a slide show is created on the basis of photographs taken by the user of the terminal 200, the user of the terminal 200 oneself will not appear in the slide show, such a case can be reliably avoided by creating a slide show using a photograph taken by a person other than the user of the terminal 200.

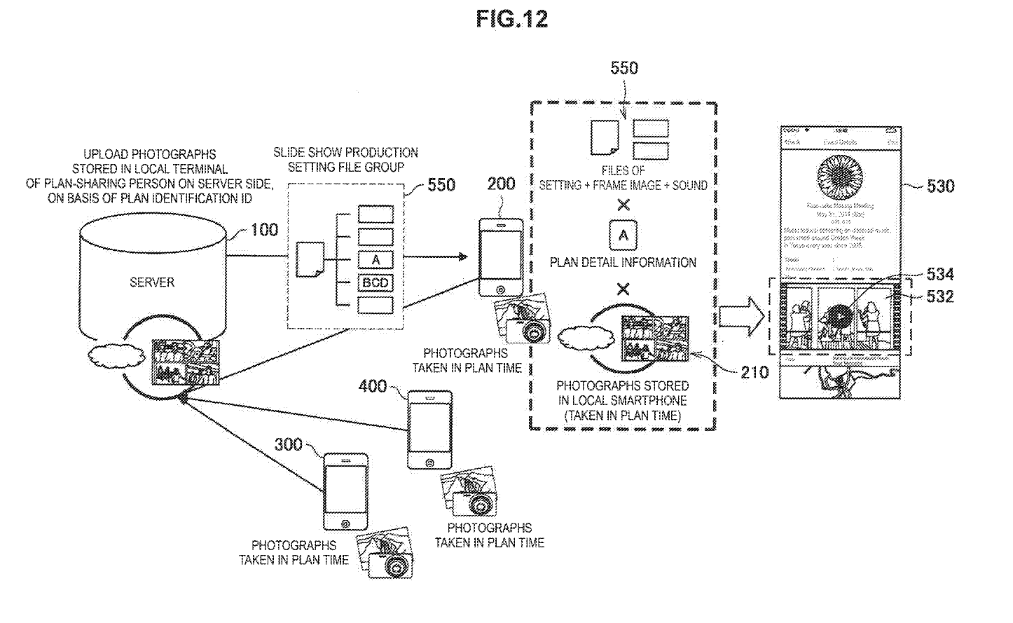

FIG. 12 is a schematic diagram showing the case of creating a slide show using images taken by a plurality of users. As shown in FIG. 12, photographs taken by terminals 200, 300, and 400 are transmitted together with the plan identification ID to the server 100. At this time, on the basis of the plan identification ID, the photographs existing in the local databases of the terminals 200, 300, and 400 of the persons sharing the plan are uploaded on the server 100 side.

As shown in FIG. 5, the server 100 manages the photographs (image data) 406, 416, 426, and 436 that the users of the terminals 200, 300, etc. have taken for the plan corresponding to the plan identification ID, while tying them to the UUIDs of the terminals 200, 300, etc., respectively.

In the case where the user of the terminal 200 creates a slide show corresponding to the plan identification ID shown in FIG. 5, at the time point at which the plan is completed, the photographs 406, 416, 426, and 436 taken by the terminals 200, 300, etc. are transmitted to the terminal 200. At this time, the transmission to the terminal 200 of a photograph unrelated to the plan for which a slide show is created can be prevented by transmitting only the photographs 406, 416, 426, and 436 tied to the plan identification ID of the plan to the terminal 200.

At the time point at which the plan has ended, the terminal 200 creates a slide show by the method described above using the data of the photographs 406, 416, 426, and 436 transmitted from the server 100, on the basis of the slide show production setting file group and the plan information.

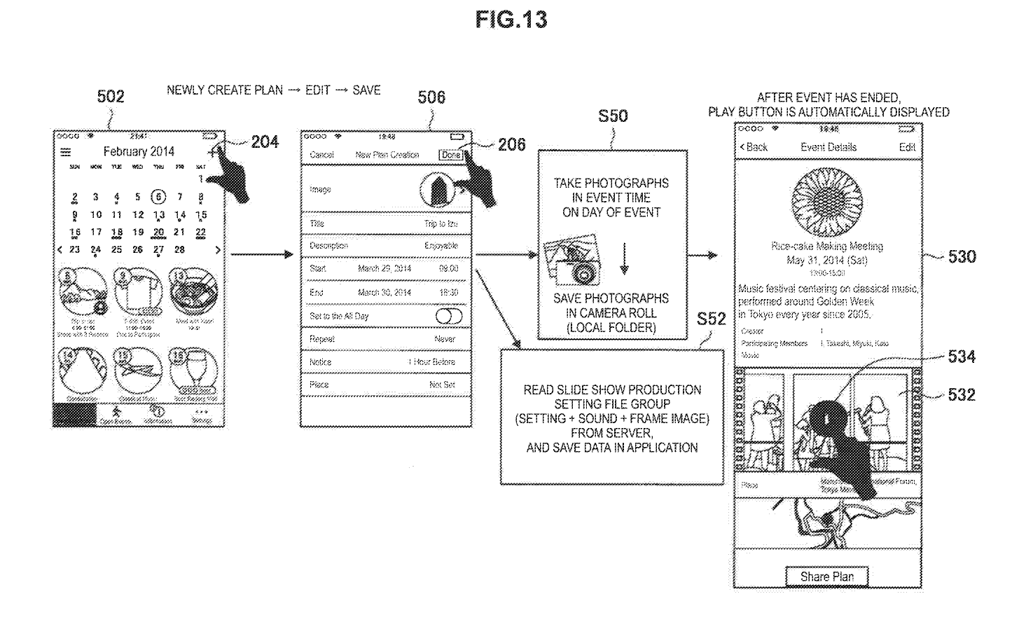

FIG. 13 is a schematic diagram summarizing the processing up to slide show creation. FIG. 13 shows the case of creating a slide show only from photographs taken by the terminal 200. Like in FIG. 2 and FIG. 3, when button 204 is pushed in screen 502, the screen transitions to screen 506. The user may newly create a plan on screen 506 and push button 206; thus, the new plan is registered in the terminal.

After that, in step S50, when the user takes photographs in the time between the start and the end of the plan information on the day of the created plan, the data of the photographs taken in the time are saved in the database 210 of the terminal 200. Further, in step S52, the terminal 200 reads a slide show production setting file group from the server 100, and saves the data in the database 210.

After that, at the time point at which the plan has ended, the terminal 200 automatically creates a movie using the data of the photographs stored in the database 210 of the terminal 200, on the basis of the slide show production setting file group and the plan information. Thereby, after the plan has ended, play button 534 is automatically displayed in screen 530 of the terminal 200. By pushing play button 534, the user can play the slide show that the terminal 200 has automatically created.

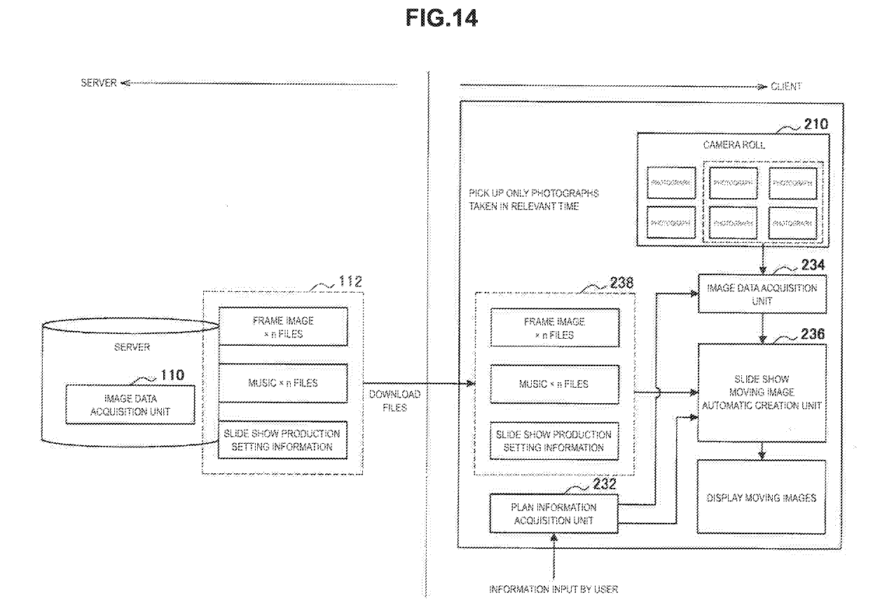

FIG. 14 is a schematic diagram showing the configuration of the terminal 1.0 200 and the server 100 for automatically creating a slide show. As shown in FIG. 14, the terminal 200 is configured to include a plan information acquisition unit (plan period acquisition unit) 232, an image data acquisition unit 234, a slide show automatic creation unit (video file creation unit) 236, and an information-for-slide-show-creation acquisition unit 238. As shown in FIG. 13, the data of the photographs taken by the user are saved in the database 210 of the terminal 200.

Information for slide show creation is retained in an information-for-slide-show-creation retention unit 112 of the server 100. The information for slide show creation includes frame image data (n files), music data (n files), slide show production setting information, etc.

The server 100 includes an image data acquisition unit 110 in addition to the configuration of FIG. 1. The image data acquisition unit 110 acquires, from the terminals 200 and 300, image data captured in the period from the start to the end of the plan on the basis of the plan information. The image data acquisition unit 234 of the terminal 200 acquires the image data that the image data acquisition unit 110 of the server 100 has acquired from the terminal 300.

Further, the server 100 transmits the information for slide show creation to the terminal 200. The transmitted information for slide show creation is acquired by the information-for-slide-show-creation acquisition unit 238 of the terminal 200. On the basis of the plan information, the image data acquisition unit 234 of the terminal 200 acquires image data captured in the period from the start to the end of the plan, out of the image data of the photographs saved in the database. At the time point at which the plan has ended, the slide show automatic creation unit 236 automatically creates a movie using the image data acquired by the image data acquisition unit 234, on the basis of the information for slide show creation and the plan information.

As described hereinabove, by the embodiment, a video file can be automatically created on the basis of the plan information after the plan has ended. Therefore, the user can play a file and enjoy video images created using video images that will be retained in the user's memory, without performing complicated manipulations.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing device including:

a plan period acquisition unit configured to acquire a period from a start to an end of a plan on the basis of plan information regarding the plan;

an image data acquisition unit configured to, after the period of the plan has elapsed, acquire image data captured in the period; and

a video file creation unit configured to create a video file in which the image data are combined.

(2)

The information processing device according to (1), wherein the video file creation unit creates a slide show as the video file.

(3)

The information processing device according to(1) or (2), wherein the video file creation unit creates the video file further using information other than the period included in the plan information.

(4)

The information processing device according to any of (1) to (3), wherein the video file creation unit creates the video file on the basis of information for video file creation in which a specification for creating the video file is prescribed.

(5)

The information processing device according to (4), including a receiving unit configured to receive the information for video file creation from a server configured to manage the plan information.

(6)

The information processing device according to (1), including an imaging unit configured to image a subject,

wherein the image data acquisition unit acquires the image data captured by the imaging unit.

(7)

The information processing device according to (1), wherein the image data acquisition unit acquires the image data captured by another device in the period from a server configured to manage the plan information.

(8)

The information processing device according to (4), wherein the information for video file creation includes a production target condition indicating that the video file is for a general user or for a company, a background image, a sound, a production pattern including a display time or a production technique, or detail information regarding display.

(9)

The information processing device according to (8), wherein, in a case where the video file is for a specific company, the information for video file creation includes information for causing the video file for an advertisement of the specific company or the video file in line with an image of the specific company to be created.

(10)

The information processing device according to (8), wherein, in a case where the video file is for a specific event, the information for video file creation includes information for causing the video file in line with an image of the specific event to be created.

(11)

An information processing method including:

acquiring a period from a start to an end of a plan on the basis of plan information regarding the plan;

acquiring, after the period of the plan has elapsed, image data captured in the period; and

creating a video file in which the image data are combined.

(12)

A program for causing a computer to function as:

a means for acquiring a period from a start to an end of a plan on the basis of plan information regarding the plan;

a means for acquiring, after the period of the plan has elapsed, image data captured in the period; and

a means for creating a video file in which the image data are combined.

(13)

A server including:

an image data acquisition unit configured to acquire, from a first device, image data captured in a period from a start to an end of a plan on the basis of plan information regarding the plan; and

a transmission unit configured to transmit the image data to a second device in order for the second device to create a video file in which the image data and image data captured by the second device in the period are combined.

(14)

An information processing method including:

acquiring, from a first device, image data captured in a period from a start to an end of a plan on the basis of plan information regarding the plan; and

performing transmission with a transmission unit configured to transmit the image data to a second device in order for the second device to create a video file in which the image data and image data captured by the second device in the period are combined.

(15)

A program for causing a computer to function as:

a means for acquiring, from a first device, image data captured in a period from a start to an end of a plan on the basis of plan information regarding the plan; and

a means for performing transmission with a transmission unit configured to transmit the image data to a second device in order for the second device to create a video file in which the image data and image data captured by the second device in the period are combined.

(16)

An information processing system including:

a server including
an image data acquisition unit configured to acquire, from a first device, a first piece of image data captured by the first device in a period from a start to an end of a plan on the basis of plan information regarding the plan, and
a transmission unit configured to transmit the first piece of image data to a second device; and

the second device including
an imaging unit configured to image a subject,
a plan period acquisition unit configured to acquire the period from the start to the end of the plan on the basis of the plan information,
an image data acquisition unit configured to acquire, after the period of the plan has elapsed, a second piece of image data captured by the imaging unit in the period,
a receiving unit configured to receive the first piece of image data transmitted from the server, and
a video file creation unit configured to create a video file in which the first piece of image data and the second piece of image data are combined,

### REFERENCE SIGNS LIST

100 server
102 communication unit
110 image data acquisition unit
200, 300 terminal
232 plan information acquisition unit (plan period acquisition unit)
234 image data acquisition unit
236 slide

1. An information processing device comprising:
a plan period acquisition unit configured to acquire a period from a start to an end of a plan on the basis of plan information regarding the plan;
an image data acquisition unit configured to, after the period of the plan has elapsed, acquire image data captured in the period; and
a video file creation unit configured to create a video file in which the image data are combined.

2. The information processing device according to claim 1, wherein the video file creation unit creates a slide show as the video file.

3. The information processing device according to claim 1, wherein the video file creation unit creates the video file further using information other than the period included in the plan information.

4. The information processing device according to claim 1, wherein the video file creation unit creates the video file on the basis of information for video file creation in which a specification for creating the video file is prescribed.

5. The information processing device according to claim 4, comprising a receiving unit configured to receive the information for video file creation from a server configured to manage the plan information.

6. The information processing device according to claim 1, comprising an imaging unit configured to image a subject,
wherein the image data acquisition unit acquires the image data captured by the imaging unit.

7. The information processing device according to claim 1, wherein the image data acquisition unit acquires the image data captured by another device in the period from a server configured to manage the plan information.

8. The information processing device according to claim 4, wherein the information for video file creation includes a production target condition indicating that the video file is for a general user or for a company, a background image, a sound, a production pattern including a display time or a production technique, or detail information regarding display.

9. The information processing device according to claim 8, wherein, in a case where the video file is for a specific company, the information for video file creation includes information for causing the video file for an advertisement of the specific company or the video file in line with an image of the specific company to be created.

10. The information processing device according to claim 8, wherein, in a case where the video file is for a specific event, the information for video file creation includes information for causing the video file in line with an image of the specific event to be created.

11. An information processing method comprising:
acquiring a period from a start to an end of a plan on the basis of plan information regarding the plan;
acquiring, after the period of the plan has elapsed, image data captured in the period; and
creating a video file in which the image data are combined.

12. A program for causing a computer to function as:
a means for acquiring a period from a start to an end of a plan on the basis of plan information regarding the plan;
a means for acquiring, after the period of the plan has elapsed, image data captured in the period; and
a means for creating a video file in which the image data are combined.

13. A server comprising:
an image data acquisition unit configured to acquire, from a first device, image data captured in a period from a start to an end of a plan on the basis of plan information regarding the plan; and
a transmission unit configured to transmit the image data to a second device in order for the second device to create a video file in which the image data and image data captured by the second device in the period are combined.

14. An information processing method comprising:
acquiring, from a first device, image data captured in a period from a start to an end of a plan on the basis of plan information regarding the plan; and
performing transmission with a transmission unit configured to transmit the image data to a second device in order for the second device to create a video file in which the image data and image data captured by the second device in the period are combined.

15. A program for causing a computer to function as:
a means for acquiring, from a first device, image data captured in a period from a start to an end of a plan on the basis of plan information regarding the plan; and
a means for performing transmission with a transmission unit configured to transmit the image data to a second device in order for the second device to create a video file in which the image data and image data captured by the second device in the period are combined.

16. An information processing system comprising:
a server including
an image data acquisition unit configured to acquire, from a first device, a first piece of image data captured by the first device in a period from a start to an end of a plan on the basis of plan information regarding the plan, and
a transmission unit configured to transmit the first piece of image data to a second device; and
the second device including
an imaging unit configured to image a subject,
a plan period acquisition unit configured to acquire the period from the start to the end of the plan on the basis of the plan information,
an image data acquisition unit configured to acquire, after the period of the plan has elapsed, a second piece of image data captured by the imaging unit in the period,
a receiving unit configured to receive the first piece of image data transmitted from the server, and
a video file creation unit configured to create a video file in which the first piece of image data and the second piece of image data are combined.
